(19) United States
(12) Patent Application Publication
(10) Pub. No.: US 2012/0176922 A1
(43) Pub. Date: Jul. 12, 2012

(54) DOWNLINK FLOW CONTROL BY ADDING NOISE TO A RECEIVER TO REDUCE PHYSICAL LAYER THROUGHPUT

(75) Inventors: Navid Ehasan, San Diego, CA (US); Thomas Klingenbrunn, San Diego, CA (US); Brian Clarke Banister, San Diego, CA (US); Michael L. McCloud, San Diego, CA (US); Levent Aydin, San Diego, CA (US)

(73) Assignee: QUALCOMM Incorporated, San Diego, CA (US)

(21) Appl. No.: 13/344,322

(22) Filed: Jan. 5, 2012

Related U.S. Application Data
(60) Provisional application No. 61/430,888, filed on Jan. 7, 2011.

(51) Int. Cl. H04W 24/00

(52) U.S. Cl. 370/252

(57) ABSTRACT

Aspects of the present disclosure relate to wireless communications and techniques and apparatus for downlink flow control at the physical layer of a user equipment (UE). Aspects generally include monitoring one or more parameters related to the UE and intentionally reducing channel quality based on the one or more parameters to trigger downlink flow control. According to aspects, channel quality may be reduced by degrading receiver performance and/or intentionally adding noise to a signal.

### CROSS-REFERENCE TO RELATED APPLICATIONS

This application claims benefit of priority to U.S. Provisional Application Ser. No. 61/430,888, filed on Jan. 7, 2011, which is expressly herein incorporated by reference.

### BACKGROUND

1. Field

Aspects of the present disclosure generally relate to wireless communication and, more particularly, to downlink flow control by reducing physical layer throughput.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3^{rd} Generation Partnership Project (3GPP) Long Term Evolution (LTE) systems, and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. The forward communication link and the reverse communication link may be established via a single-input single-output, multiple-input single-output or a multiple-input multiple-output system.

A wireless multiple-access communication system can support a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

The 3GPP LTE represents a major advance in cellular technology and it is a next step forward in cellular 3^{rd} generation (3G) services as a natural evolution of Global System for Mobile Communications (GSM) and Universal Mobile Telecommunications System (UMTS). The LTE provides for an uplink speed of up to 75 megabits per second (Mbps) and a downlink speed of up to 300 Mbps, and brings many technical benefits to cellular networks. The LTE is designed to meet carrier needs for high-speed data and media transport as well as high-capacity voice support. The bandwidth may be scalable from 1.25 MHz to 20 MHz. This suits the requirements of different network operators that have different bandwidth allocations, and also allows operators to provide different services based on spectrum. The LTE is also expected to improve spectral efficiency in 3G networks, allowing carriers to provide more data and voice services over a given bandwidth.

Physical layer (PHY) of the LTE standard is a highly efficient means of conveying both data and control information between an enhanced base station (eNodeB) and mobile user equipment (UE). The LTE PHY employs advanced technologies that are new to cellular applications. These include Orthogonal Frequency Division Multiplexing (OFDM) and Multiple Input Multiple Output (MIMO) data transmission. In addition, the LTE PHY uses OFDMA on the downlink and Single Carrier -Frequency Division Multiple Access (SC-FDMA) on the uplink. OFDMA allows data to be directed to or from multiple users on a subcarrier-by-subcarrier basis for a specified number of symbol periods.

3GPP LTE Release 8 specifications provide a set of frequency bands on which an LTE system can be deployed. The usage of bands can vary from country to country based on prevalent frequency allocation policies. Within a band, an actual carrier frequency being utilized can also vary from one service provider to another. The 3GPP USIM (UMTS Subscriber Identity Module) may only provide a list of PLMN IDs (Public Land Mobile Network Identifications), which may comprise a 3-bit Mobile Country Code (MCC) and a 3-bit Network Color Code (NCC). However, the PLMN ID may not provide an indication about a band to be used, and, also, it may not comprise information about a specific carrier frequency on which a desired service provider exists. User equipment (UE) operating in the LTE system may be supposed to learn and maintain an adaptive list of carrier frequencies and band information as it successfully acquires services in various countries and service providers. Hence, the UE may be required to always perform a frequency scan when attempting initial acquisition.

### SUMMARY

In an aspect of the disclosure, a method for wireless communications is provided. The method generally includes monitoring one or more parameters related to a wireless communications apparatus and intentionally reducing channel quality based on the one or more parameters.

In an aspect of the disclosure, an apparatus for wireless communications is provided. The apparatus generally includes means for monitoring one or more parameters related to a wireless communications apparatus and means for intentionally reducing channel quality based on the one or more parameters.

In an aspect of the disclosure, an apparatus for wireless communications is provided. The apparatus generally includes at least one processor and a memory coupled to the at least one processor. The at least one processor is generally configured to monitor one or more parameters related to a wireless communications apparatus and intentionally reduce channel quality based on the one or more parameters.

In an aspect of the disclosure, a computer-program product for wireless communications is provided. The computer-program product generally includes a non-transitory computer-readable medium having code stored thereon. The code is generally executable by one or more processors for monitoring one or more parameters related to a wireless communications apparatus and intentionally reducing channel quality based on the one or more parameters.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example multiple access wireless communication system, in accordance with aspects of the present disclosure.

FIG. 2 illustrates a block diagram of an access point and a user terminal in, accordance with aspects of the present disclosure.

FIG. 3 illustrates a block diagram of an example wireless device, in accordance with aspects of the present disclosure.

FIG. 4 illustrates an example of downlink flow control, in accordance with aspects of the present disclosure.

FIG. 5 illustrates an example of altering the channel quality by adjusting an automatic gain control, in accordance with aspects of the present disclosure.

FIG. 6 illustrates examples of software layer states, in accordance with aspects of the present disclosure.

FIG. 7 illustrates example interfaces for downlink flow control, in accordance with aspects of the present disclosure.

FIG. 8 illustrates example operations performed, for example, by a UE, for downlink flow control, in accordance with aspects of the present disclosure.

### DETAILED DESCRIPTION

Aspects of the present disclosure provide techniques to implement downlink flow control due to resource limitations at a user equipment (UE). According to aspects, a wireless communications apparatus may monitor one or more parameters including, for example, temperature of the apparatus, temperature of a device on the apparatus, a memory-related parameter, and/or a processing power-related parameter. Based on the one or more monitored parameters, the apparatus may intentionally reduce channel quality by, for example, degrading receiver performance. Accordingly, aspects of the present disclosure allow a UE to reduce channel quality in an effort to reduce a downlink data rate and help free resources at the device.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that use E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

An access point (“AP”) may comprise, be implemented as, or known as NodeB, Radio Network Controller (“RNC”), eNodeB (“eNB”), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment (“UE”), a user station, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects the node is a wireless node. Such wireless node may provide, for example, connectivity for or to a network (e.g., a wide area network such as the Internet or a cellular network) via a wired or wireless communication link.

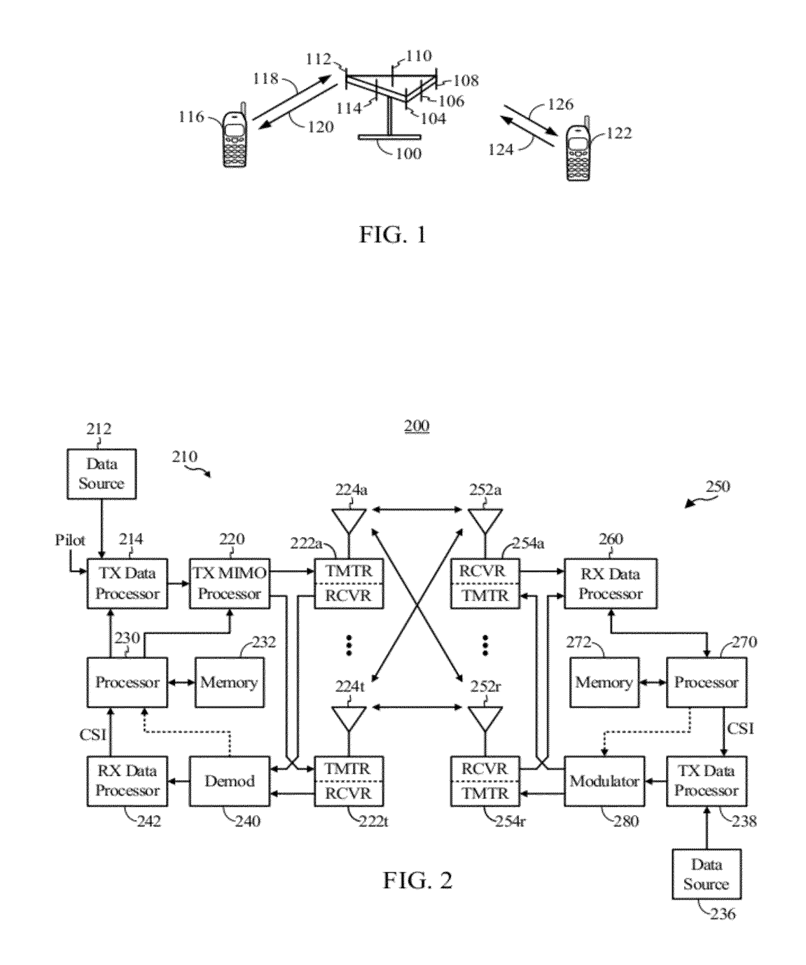

Referring to FIG. 1, a multiple access wireless communication system according to one aspect of the present disclosure is illustrated. An access point 100 (AP) may include multiple antenna groups, one group including antennas 104 and 106, another group including antennas 108 and 110, and an additional group including antennas 112 and 114. In FIG. 1, only two antennas are shown for each antenna group, however, more or fewer antennas may be utilized for each antenna group. Access terminal 116 (AT) may be in communication with antennas 112 and 114, where antennas 112 and 114 transmit information to access terminal 116 over forward link 120 and receive information from access terminal 116 over reverse link 118. Access terminal 122 may be in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access point. In one aspect of the present disclosure each antenna group may be designed to communicate to access terminals in a sector of the areas covered by access point 100.

In communication over forward links 120 and 126, the transmitting antennas of access point 100 may utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

FIG. 2 illustrates a block diagram of an aspect of a transmitter system 210 (also known as the access point) and a receiver system 250 (also known as the access terminal) in a multiple-input multiple-output (MIMO) system 200. At the transmitter system 210, traffic data for a number of data streams is provided from a data source 212 to a transmit (TX) data processor 214.

In one aspect of the present disclosure, each data stream may be transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects of the present disclosure, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals may be received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and further process the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 may be complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights, and then processes the extracted message.

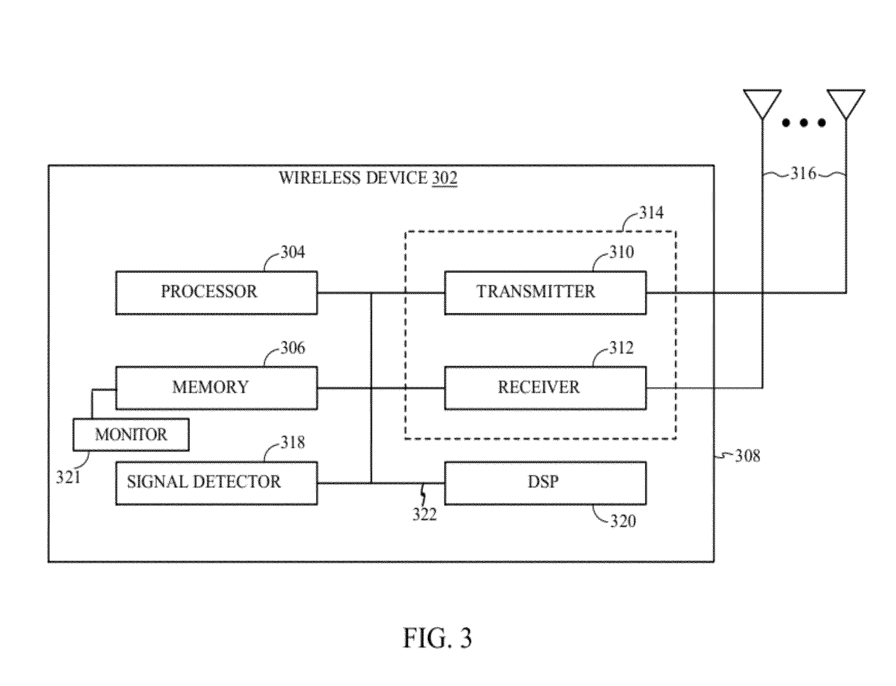

FIG. 3 illustrates various components that may be utilized in a wireless device 302 that may be employed within the wireless communication system from FIG. 1. The wireless device 302 is an example of a device that may be configured to implement the various methods described herein. The wireless device 302 may be an access point 100 from FIG. 1 or any of access terminals 116, 122.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals. In some aspects, the wireless device 302 may include one or more monitors, for example, a memory monitor 321. The memory monitor 321 is configured to monitor one or more memory-related parameters or metrics, for example, if a UE begins to run out of global memory. A UE may begin to run out of memory, for example distributed shared memory (DSM) items, when the UE has too much data stored in uplink and downlink buffers. While the monitor is shown as a memory monitor 321 in FIG. 3, it is contemplated that certain aspects of the present disclosure may utilize other and/or additional suitable monitors, including but not limited to a CPU monitor and a temperature monitor, having one or more corresponding sensor components for detecting one or more UE parameters or metrics.

The various components of the wireless device 302 may be coupled together by a bus system 322, which may include a power bus, a control signal bus, and a status signal bus in addition to a data bus.

Certain aspects of the present disclosure support methods for performing frequency scan by user mobile device, such as the access terminals 116, 122 from FIG. 1, the access terminal 250 from FIG. 2 and the wireless device 302 from FIG. 3. In an aspect, the frequency scan may be performed without any prior acquisition information at the mobile device, which may be referred to as Full Frequency Scan (FFS). In another aspect, the frequency scan may be performed using prior successful acquisition information stored at the mobile device, which may be referred to as List Frequency Scan (LFS). The 3GPP LTE system may be deployed using either frequency division duplex (FDD) mode or time division duplex (TDD) mode. The proposed frequency scan algorithms (i.e., the FFS and LFS) may support both the FDD and TDD modes of operation.

### LTE Downlink Flow Control—Physical Layer Approach

Due to resource limitations at a UE, in certain scenarios, downlink flow control may be desirable. System limitations such as, for example, memory size, processing power, and/or acceptable device temperature may be used to trigger downlink flow control. Various techniques are described herein with reference to an LTE network as a specific, but not limiting, example of a network in which the techniques may be used. However, those skilled in the art will appreciate that the techniques may be applied more generally in various types of wireless networks.

As will be described in more detail below, downlink flow control may be triggered due to resource limitations at a UE. According to aspects, a UE may monitor one or more parameters including, for example, temperature of the apparatus, temperature of a device on the apparatus, a memory-related parameter, and/or a processing power-related parameter.

Based on the one or more monitored parameters, receiver performance may be intentionally reduced in an effort to decrease a channel quality indicator (CQI), reduce a downlink data rate, and free resources at the UE. According to aspects, the UE may transmit an indication of the intentionally reduced channel quality to a BS for use in scheduling transmissions. The indication may be one of a channel quality indicator (CQI), received carrier-to-interference-and-noise ratio (CINR), received signal strength indicator (RSSI), and/or block error rate (BLER).

Degrading receiver performance may allow for alignment of calculated CQI and hybrid automatic repeat request (HARQ) negative acknowledgments (NACKs). For example, the HARQ NACK error rate may automatically correspond to the reported CQI due to an intentional degradation in receiver performance. Accordingly, aspects presented herein may allow for quality of service (QoS) control by a BS using only one control loop for adding noise to the receiver and may cover different CQI reporting mechanisms (e.g., wide band, network band selective, UE band selective). In aspects, the intentional degradation in receiver performance may be periodic. In this manner, the degradation may be time varying (e.g., to a BS).

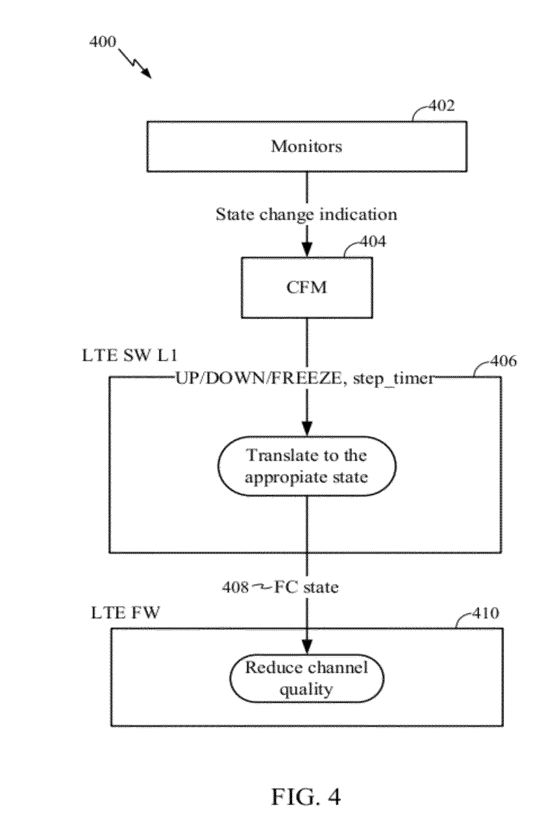

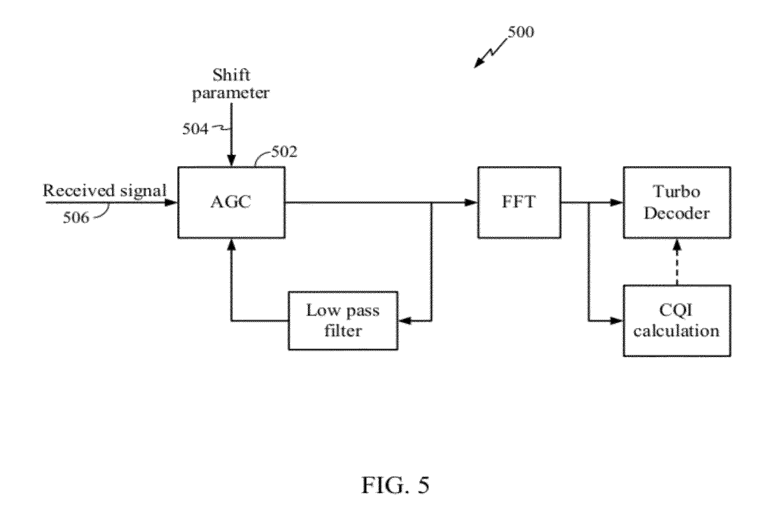

FIG. 4 illustrates an example centralized flow control manager (CFM) architecture 400, in accordance with aspects of the present disclosure. CFM 404 may receive indications from one or more monitors 402. The one or more monitors 402 may observe one or more parameters related to the UE including, for example, temperature of the UE and/or temperature of device on the UE (e.g., modem). Additionally or alternatively, monitors 402 may observe a memory-related parameter and/or a processing power-related parameter of the UE.

Based at least in part on the one or more monitored parameters, CFM 404 may determine whether DL flow control is needed. CFM 404 may determine flow control is needed due to resource limitations at the UE including, for example, central processing unit (CPU) overload, modem temperature, and/or universal serial bus (USB) current. When downlink flow control is needed, CFM 404 may send an indication to a software layer 406. Software layer 406 may determine the flow control desired based on the commands received from CFM 404. Software layer 406 may send the desired flow control state 408 to firmware layer 410 in an effort to reduced channel quality at the UE.

FIG. 5 illustrates an example of downlink flow control by reducing the channel quality of a received signal 500, according to aspects of the present disclosure. When the CFM determines downlink flow control is needed, an automatic gain control (AGC) module 502 in a receiver may be shifted in an effort to reduce a signal to quantization noise ratio (SQNR). By reducing the SQNR, the received signal may move closer to noise and the receiver may transmit more negative acknowledgments (NACKs) to a transmitter due to the degraded receiver performance. Accordingly, the CQI calculated by the UE may decrease and may properly align with the transmitted NACKs.

A shift parameter n 504 (e.g., an AGC parameter) may be input into the AGC module 502 to trigger downlink flow control. The shift parameter n 504 may reduce the amplitude of the received signal 506 by 2ⁿ. According to aspects, increasing n by one may reduce the SQNR (e.g., S/(N+Q)) by 6 dB, assuming Q>>N. Although, in other aspects, an adjustment in n may adjust the SQNR by a larger or smaller amount.

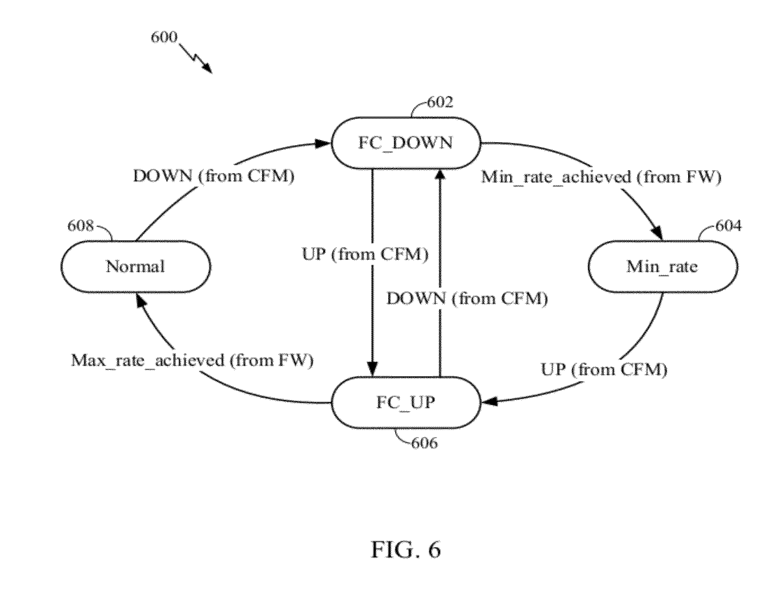

FIG. 6 illustrates example software layer states 600 in accordance with aspects of the present disclosure. As previously described with reference to FIG. 4, a software layer (e.g., LTE SW Layer 1) may serve as an interface between the CFM and firmware. The software layer may receive up and/or down commands from the CFM and may send the commands to the firmware. The CFM may know the data rate but may not know the SQNR. Accordingly, the software layer may maintain a desired flow control state and may keep track of the shifts in the AGC parameter.

As will be described in more detail below, the software layer may track increases and/or decreases of the AGC shift parameter using a step timer. After the step timer elapses, the software layer may determine if the change in the AGC shift parameter produced the desired result on the downlink data rate.

The software layer may increase the AGC shift parameter, and therefore reduce the SQNR, by sending a flow control down command to the firmware. Upon expiry of the step timer, the software layer may determine if the desired downlink data rate has been reached. If further downlink flow control is needed, for example, the software layer may send another down command to the firmware.

According to aspects, the software layer may decrease the AGC shift parameter, and therefore increase the SQNR, by sending a flow control up command to the firmware. Upon expiry of the step timer, the software layer may determine if the desired downlink data rate has been reached. If less downlink flow control is needed, for example, the software layer may send another up command to the firmware.

Referring to FIG. 6, at 602, the software layer may receive a down command from the CFM. This command may be based in part on one or more monitored parameters at the UE. During the flow control down state, the software layer may transmit a down command to the firmware and may either start or re-start a step timer. Upon expiry of the step timer, the software layer may transmit a down command to the firmware and re-start the step timer if further downlink flow control is desired. If the software layer receives an up command from the CFM while in the flow control down state, it may transition to theflow control up state.

At 604, the software layer may receive an indication from the firmware that a minimum data rate has been reached and no more down commands may be allowed. Alternatively, during the minimum rate state, the firmware may ignore any received down commands.

At 606, the software layer may receive an up command from the CFM. During theflow control up state, the software layer may transmit an up command to the firmware and start or re-start a step timer. Upon expiry of the step timer, the software layer may transmit an up command to the firmware and re-start the step timer if less downlink flow control is desired. If the software layer receives a down command from the CFM while in the flow control up state, it may transition to the flow control down state.

At 608, the software layer may receive an indication from the firmware that a maximum data rate has been reached and the software layer may enter a normal state. According to aspects, the software layer may remain in the normal state until it receives an indication, via a down command, from the CFM to trigger downlink flow control.

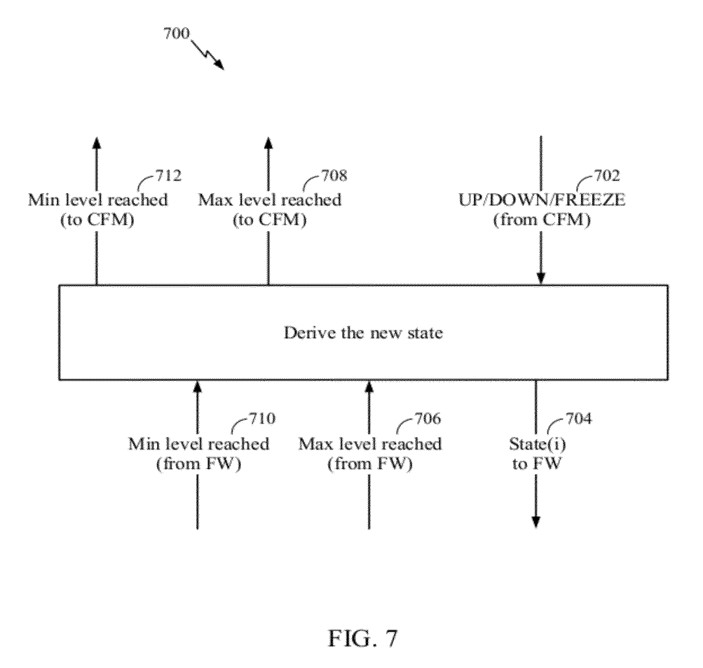

FIG. 7 illustrates example interfaces that may be used for downlink flow control 700, in accordance with aspects of the present disclosure. The software layer may register with the CFM, receive commands from the CFM, and send a new state to the firmware. For example, at 702, the software layer may receive a command from the CFM. The command may be an up, down, or freeze command. At 704, the software layer may send a new flow control state to the firmware.

When a maximum data rate has been reached, at 706, the software layer may receive maximum level reached indication from the firmware. At 708, the software layer may send the maximum level reached to the CFM. Similarly, when a minimum data rate has been reached, at 710, the software layer may receive a minimum level reached indication from the firmware. At 712, the software layer may send the minimum level reached to the CFM.

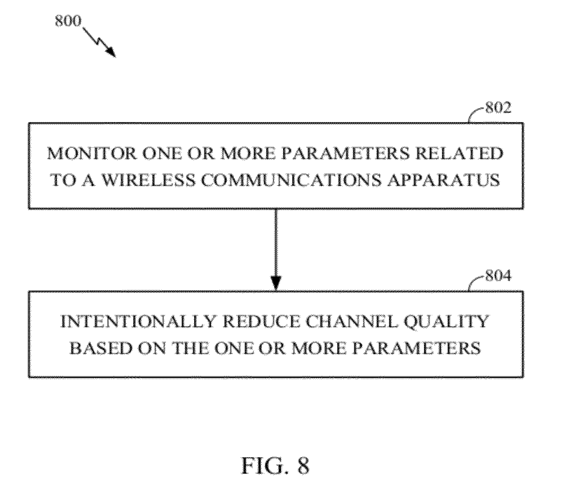

FIG. 8 illustrates example operations 800 which may be performed for downlink flow control at the physical layer, for example by a UE, according to aspects of the present disclosure.

At 802, a UE may monitor one or more parameters related to the UE. At 804, the UE may intentionally reduce channel quality based on the one or more parameters.

Intentionally reducing the channel quality based on the one or more parameters may comprise intentionally adding noise to a received signal. For example, the noise may be analog noise (e.g., noise added to a receiver RF unit) and/or digital pseudo noise. According to aspects, intentionally reducing channel quality based on the one or more parameters may comprise controlling an AGC parameter. As previously described, controlling the AGC parameter may comprise controlling an AGC shift in an effort to increase quantization noise level. The method may further comprise transmitting an indication of the intentionally reduced channel quality to a base station for use in scheduling. The indication may comprise at least one of CQI, CINR, RSSI, or BLER.

Aspects of the present disclosure provide methods and apparatus to implement downlink flow control due to resource limitations at a user equipment (UE). According to aspects, a wireless communications apparatus may monitor one or more parameters including, for example, temperature of the apparatus, temperature of a device on the apparatus, a memory-related parameter, and/or a processing power-related parameter. Based on the one or more monitored parameters, the apparatus may intentionally reduce channel quality by, for example, degrading receiver performance. Accordingly, aspects of the present disclosure allow a UE to reduce channel quality in an effort to reduce a downlink data rate and help free resources at the device.

Aspects of the present disclosure provide techniques for downlink flow control based on parameters observed at a UE. Due to resource limitations at a UE, downlink flow control may be necessary to reduce a downlink data rate and help free resources at the UE. As described herein, based on one or more monitored parameters, receiver performance may be intentionally degraded in an effort to trigger downlink flow control. Degrading receiver performance when downlink flow control is desired may reduce a calculated CQI. Due to degraded receiver performance, the receiver may send more NACKs to a transmitting base station. Accordingly, the calculated CQI and HARQ NACKs may be aligned.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communications, comprising:
monitoring one or more parameters related to a wireless communications apparatus; and
intentionally reducing channel quality based on the one or more parameters.

2. The method of claim 1, wherein intentionally reducing the channel quality based on the one or more parameters comprises:
intentionally adding noise to a received signal.

3. The method of claim 1, wherein intentionally reducing the channel quality based on the one or more parameters comprises:
controlling an automatic gain control (AGC) parameter.

4. The method of claim 3, wherein controlling the automatic gain control (AGC) parameter comprises:
controlling an AGC shift in an effort to increase quantization noise level.

5. The method of claim 1, wherein the one or more parameters comprise:
at least one of a temperature of the wireless communications apparatus or a temperature of a device on the wireless communications apparatus.

6. The method of claim 1, wherein the one or more parameters comprise:
at least one of a memory-related parameter or a processing power-related parameter.

7. The method of claim 1, further comprising:
transmitting an indication of the intentionally reduced channel quality to a base station for use in scheduling.

8. The method of claim 7, wherein the indication comprises at least one of: Channel Quality Indicator (CQI), received Carrier-to-Interference-and-Noise Ratio (CINR), Received Signal Strength Indicator (RSSI), or Block Error Rate (BLER).

9. The method of claim 1 further comprising intentionally increasing channel quality based on the one or more parameters.

10. An apparatus for wireless communications, comprising:
means for monitoring one or more parameters related to a wireless communications apparatus; and
means for intentionally reducing channel quality based on the one or more parameters.

11. The apparatus of claim 10, wherein the means for intentionally reducing the channel quality based on the one or more parameters comprises:
means for intentionally adding noise to a received signal.

12. The apparatus of claim 10, wherein the means for intentionally reducing the channel quality based on the one or more parameters comprises:
means for controlling an automatic gain control (AGC) parameter.

13. The apparatus of claim 12, wherein the means for controlling the automatic gain control (AGC) parameter comprises:
means for controlling an AGC shift in an effort to increase quantization noise level.

14. The apparatus of claim 10, wherein the one or more parameters comprise:
at least one of a temperature of the wireless communications apparatus or a temperature of a device on the wireless communications apparatus.

15. The apparatus of claim 10, wherein the one or more parameters comprise:
at least one of a memory-related parameter or a processing power-related parameter.

16. The apparatus of claim 10, further comprising:
means for transmitting an indication of the intentionally reduced channel quality to a base station for use in scheduling.

17. The apparatus of claim 16, wherein the indication comprises at least one of:
Channel Quality Indicator (CQI), received Carrier-to-Interference-and-Noise Ratio (CINR), Received Signal Strength Indicator (RSSI), or Block Error Rate (BLER).

18. The apparatus of claim 10 further comprising means for intentionally increasing channel quality based on the one or more parameters.

19. An apparatus for wireless communications, comprising:
at least one processor configured to:
monitor one or more parameters related to a wireless communications apparatus; and
intentionally reduce channel quality based on the one or more parameters; and
a memory coupled to the at least one processor.

20. The apparatus of claim 19, wherein the at least one processor is configured to intentionally reduce the channel quality based on the one or more parameters by:
intentionally adding noise to a received signal.

21. The apparatus of claim 19, wherein the at least one processor is configured to intentionally reduce the channel quality based on the one or more parameters by:
controlling an automatic gain control (AGC) parameter.

22. The apparatus of claim 21, wherein the at least one processor is configured to control the automatic gain control (AGC) parameter by:
controlling an AGC shift in an effort to increase quantization noise level.

23. The apparatus of claim 19, wherein the one or more parameters comprise:
at least one of a temperature of the wireless communications apparatus or a temperature of a device on the wireless communications apparatus.

24. The apparatus of claim 19, wherein the one or more parameters comprise:
at least one of a memory-related parameter or a processing power-related parameter.

25. The apparatus of claim 19, wherein the at least one processor is further configured to:
transmit an indication of the intentionally reduced channel quality to a base station for use in scheduling.

26. The apparatus of claim 25, wherein the indication comprises at least one of:
Channel Quality Indicator (CQI), received Carrier-to-Interference-and-Noise Ratio (CINR), Received Signal Strength Indicator (RSSI), or Block Error Rate (BLER).

27. The apparatus of claim 19 wherein the at least one processor is further configured to intentionally increase channel quality based on the one or more parameters.

28. A computer-program product for wireless communication, the computer-program product comprising a non-transitory computer-readable medium having code stored thereon, the code executable by one or more processors for:
monitoring one or more parameters related to a wireless communications apparatus; and
intentionally reducing channel quality based on the one or more parameters.

29. The computer-program product of claim 28, wherein the code for intentionally reducing the channel quality based on the one or more parameters comprises:
code for intentionally adding noise to a received signal.

30. The computer-program product of claim 28, wherein the code for intentionally reducing the channel quality based on the one or more parameters comprises:
code for controlling an automatic gain control (AGC) parameter.

31. The computer-program product of claim 30, wherein the code for controlling the automatic gain control (AGC) parameter comprises:
code for controlling an AGC shift in an effort to increase quantization noise level.

32. The computer-program product of claim 28, wherein the one or more parameters comprise:
at least one of a temperature of the wireless communications apparatus or a temperature of a device on the wireless communications apparatus.

33. The computer-program product of claim 28, wherein the one or more parameters comprise:
at least one of a memory-related parameter or a processing power-related parameter.

34. The computer-program product of claim 28, further comprising:
code for transmitting an indication of the intentionally reduced channel quality to a base station for use in scheduling.

35. The computer-program product of claim 34, wherein the indication comprises at least one of: Channel Quality Indicator (CQI), received Carrier-to-Interference-and-Noise Ratio (CINR), Received Signal Strength Indicator (RSSI), or Block Error Rate (BLER).

36. The computer-program product of claim 28 further comprising code for intentionally increasing channel quality based on the one or more parameters.
